(19) United States
(12) Patent Application Publication
(10) Pub. No.: US 2014/0119821 A1
(43) Pub. Date: May 1, 2014

(54) INSERT SLOT AND METHOD OF FORMING AN INSERT SLOT IN A ROTARY HAND SLIP

(71) Applicant: Jeffrey Lee Bertelsen, Coldspring, TX (US)

(72) Inventor: Jeffrey Lee Bertelsen, Coldspring, TX (US)

(21) Appl. No.: 14/061,974

(22) Filed: Oct. 24, 2013

Related U.S. Application Data
(60) Provisional application No. 61/719,993, filed on Oct. 30, 2012.

(51) Int. Cl. F16D 1/06; B23C 3/28

(52) U.S. Cl. CPC F16D 1/06; B23C 3/28
USPC 403/345; 409/131

(57) ABSTRACT

An insert slot for a slip segment of a rotary hand slip is described. The insert slot includes a milled recess cut into a metal slip segment so as to form a rectangular-shaped insert slot designed to receive an insert therein used in the hand slip, and circular corners drilled into the slip segment at a lower corner locations of the insert slot so as to relieve two bottom end corners of the slot.

### CROSS-REFERENCE TO RELATED APPLICATION

The present application claims the benefit under 35 U.S.C. §119(e) of U.S. Provisional Patent Application No. 61/719,993 to the inventor, filed Oct. 30, 2012, the entire contents of which is hereby incorporated by reference herein.

### BACKGROUND

1. Field

Example embodiments generally relate to an insert slot for inserts of a rotary hand slip and to a method of forming the insert slot in the slip.

2. Related Art

Conventionally at an oil rig site, drill collar slips, power slips, and rotary hand slips may be used to hold tool inserts or grip inserts against drill pipe. FIG. 1 is a front view of conventional extra long rotary hand slip, and FIG. 2 is cross-sectional cut taken of the rotary hand slip attached to a portion of drill pipe. Referring to FIGS. 1 and 2, there is shown a conventional extra long rotary hand slip 100. Slip 100 includes three slip segments 110, handles 120, with each slip segment 110 having an insert slot holding a set of inserts 115 which are designed to interface and grip a pipe 150 under actuating tension of a pin drive master bushing 130 and bowl 140 on the slip 100 (slip segments 110). Typically, stresses imparted in this operation may be uneven on the insert 115, sometimes causing bowing at the toe 125 of the segment 110, to where the toe 125 may break off and fall into the drill hole.

FIG. 3 is a top view of a portion of a slip segment showing the toe of conventional insert slot design for inserts; and FIG. 4 is a side view of FIG. 3 on a slip segment. The conventional insert slot 116 for an insert 115 employs a design using a half-moon shaped button 117 to finish out the bottom of the dove tail insert groove 119. The half moon-shaped button 117 is a cast part and is put in place and welded, as shown by weld 118. The problem with this conventional insert slot design is that under stress of the weight on the inserts 115 (not shown) down on it, the cast part of the half moon 117 wants to shear the groove 119 due to the weight load. Also if the bottom of the insert 115 is tapered and does not sit on the insert slot 116 flat, the insert 115 often will pop out of the slot 116. Further, the insert 115 must be installed tight in the cutout for slot 116 or the weld 118 will break.

Another way for conventional insert slot design is to simply cut a slot straight across the bottom of the dove tail in the slip segment 110. This creates a gap and a flat bottom. The problem with this design is the cut weakens the toe 125 of the slip segment 110. This can cause the toe 125 to bend, permitting the insert 115 to come out.

FIG. 5 is a photograph of a top view of a portion of a slip segment showing the conventional insert slot design at the segment toe without inserts therein; and FIG. 6 is a photograph of a top view of a portion of a slip segment showing the conventional insert slot design with inserts installed in the slot channel. FIGS. 5 and 6 show the issues discussed above with the conventional half-moon insert slot design. Referring to FIG. 5 it can be seen in the picture without insert 115 installed that a half-moon button 117 welded piece is in place.

Three issues at least pose problems with this design. First, the slot 116 has to be machined into the toe 125 area. This area can flex or move during use, causing the button 117 to come out or loosen up. Secondly, the button 117 may not fully seat against the bottom dovetail cutout 119 formed in the slip segment 110 as the insert slot 116; thus the weight of the insert 115 would be resting on the weld 118 and not supported by slot 116. Third, and as shown in FIG. 6, when the insert 115 is installed, an interface between the bottom of the insert slot 116 and the top of the button 117 becomes very critical. If the insert 115 rests on the back edge of the half moon button 117, it will cause the half moon button 117 to pop out.

In FIG. 6 with the insert 115 installed in the slot 116, a crack can be seen around the half moon button 117. The crack (small chips in weld 118 that follows arc of button 117) has formed because the insert 115 was not fully resting on the milled insert slot 116 when the half moon button 117 was welded in place; thus the insert 115 could break out. FIG. 6 also shows how much closer the slot 116 had to be milled to the end of the slip segment that is represented by the toe 125 area.

Accordingly, with the conventional insert slot designs, the weight of the insert can sit on the weld 118, the half-moon button 117 can crack or break, and stresses on these parts can force the toe 125 of the slip segment 110 to break off into the drill hole. If the bottom angle of the inset groove is greater than 1 degree from back to front, it will not create a stable level bottom groove for the insert, acting as a cam surface to create a shear weight interface between the top of the half moon button 117 and where the bottom of the softer metal insert sits on it. As this interface is critical, the weld 118 of the half moon 117 will crack or the half moon 117 will simply pop out of its weld 118.

In fabrication, the half-moon is imprecisely saw cut, and the insert slot is milled cut. So, due to the angle on the bottom of the back surface of the insert slot 116 within the slip segment 110 being less than 90 degrees, this causes shear stress to pop the half-moon 117 out of the insert slot 116. Accordingly, an insert slot design which evenly distributes the stress of an insert 115 down onto the flat bottom within the insert slot 116 so it rests stably in a flat-bottom groove is needed.

### SUMMARY

An example embodiment is directed to an insert slot for a slip segment. The inset slot includes a milled recess and corners drilled in to relieve the bottom ends of the slot.

Another example embodiment is direction to a method of fabricating an insert slot for a slip segment. In the method, a billet of metal is straight end milled to a first depth, square end milled to square corners of the insert slot, dovetail cut to create a groove along lengthwise sides of the billet, and end milled to create corner holes at bottom end corners.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limitative of the example embodiments herein.

FIG. 1 is a front view of conventional extra long rotary hand slip.

FIG. 2 is cross-sectional cut taken of the rotary hand slip attached to a portion of drill pipe.

FIG. 3 is a top view of a portion of a slip segment showing the toe of conventional insert slot design for inserts.

FIG. 4 is a side view of FIG. 3 on a slip segment.

FIG. 5 is a photograph of a top view of a portion of a slip segment showing the conventional insert slot design at the segment toe without inserts therein.

FIG. 6 is a photograph of a top view of a portion of a slip segment showing the conventional insert slot design with inserts installed in the slot channel.

FIG. 7 is a top view of a portion of a slip segment showing the toe of an insert slot design for inserts according to an example embodiment.

FIG. 8 is a side view of FIG. 7 on a slip segment.

FIGS. 9A to 9E illustrates a process for fabricating an insert slot in a slip segment according to an example embodiment.

FIG. 10 is a photograph of a top view of a portion of a slip segment showing the insert slot design of the example embodiment at the slip segment toe without inserts therein.

FIG. 11 is a photograph of a top view of a portion of a slip segment showing the insert slot design of the example embodiment with inserts installed in the slot channel.

FIG. 12 is a photograph of a test apparatus used to test the strength of a segment toe with the insert slot design of the example embodiment.

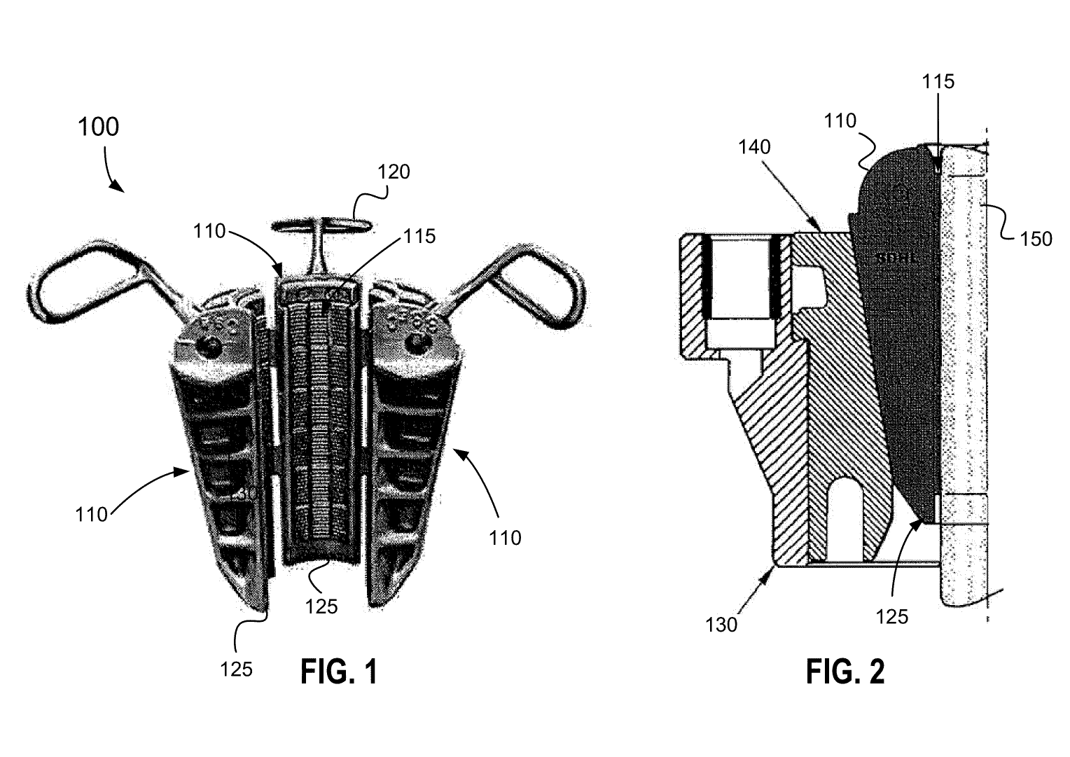

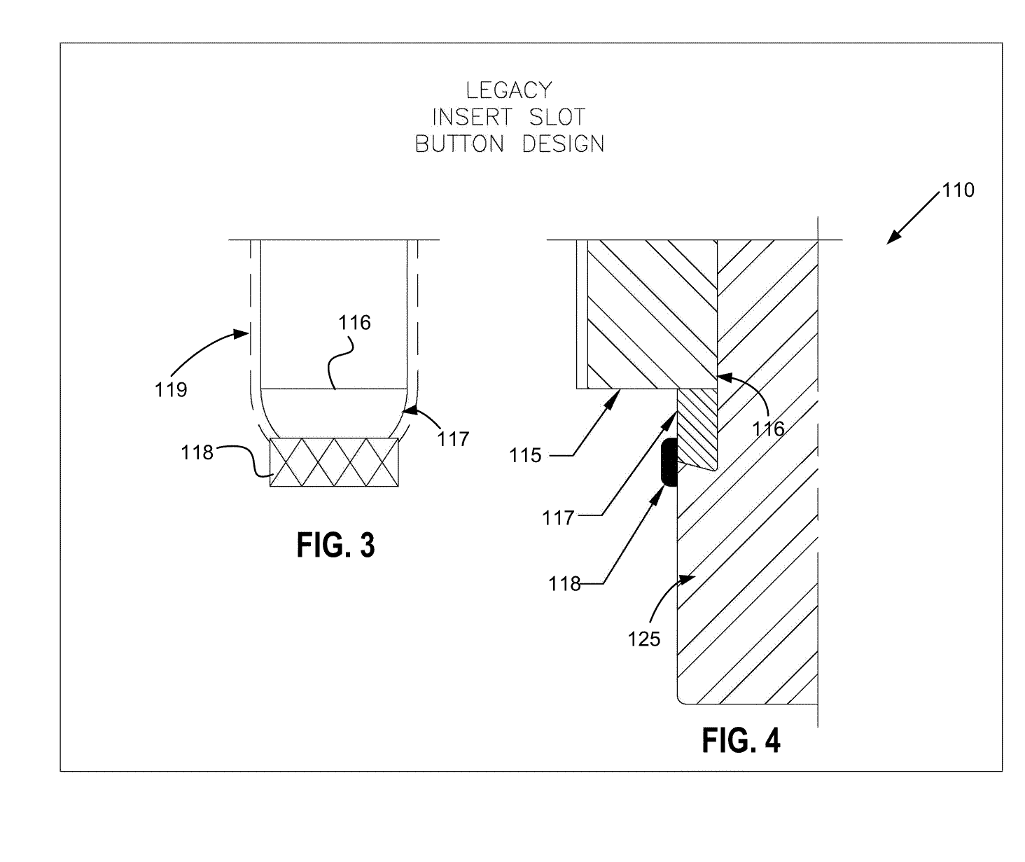

### DETAILED DESCRIPTION

As to be described hereafter, an example embodiment is directed to an insert slot for inserts of a rotary or hand slip and to a method of forming the insert slot in the slip.

As to be shown hereafter, a novel design for an insert slot to hold tool inserts or grip inserts in slips such as drill collar slips, hand slips, power slips, and the like, may provide a slip segment with an insert slot and toe that based on testing is 20% stronger than the conventional insert slot design described above. The example insert slot to be described hereafter is not subject to the limitations of the conventional insert slot. Namely, by having a flat bottom on the groove at the bottom of the insert slot, unlike the half-moon style of the conventional design, downward forces may be evenly distributed.

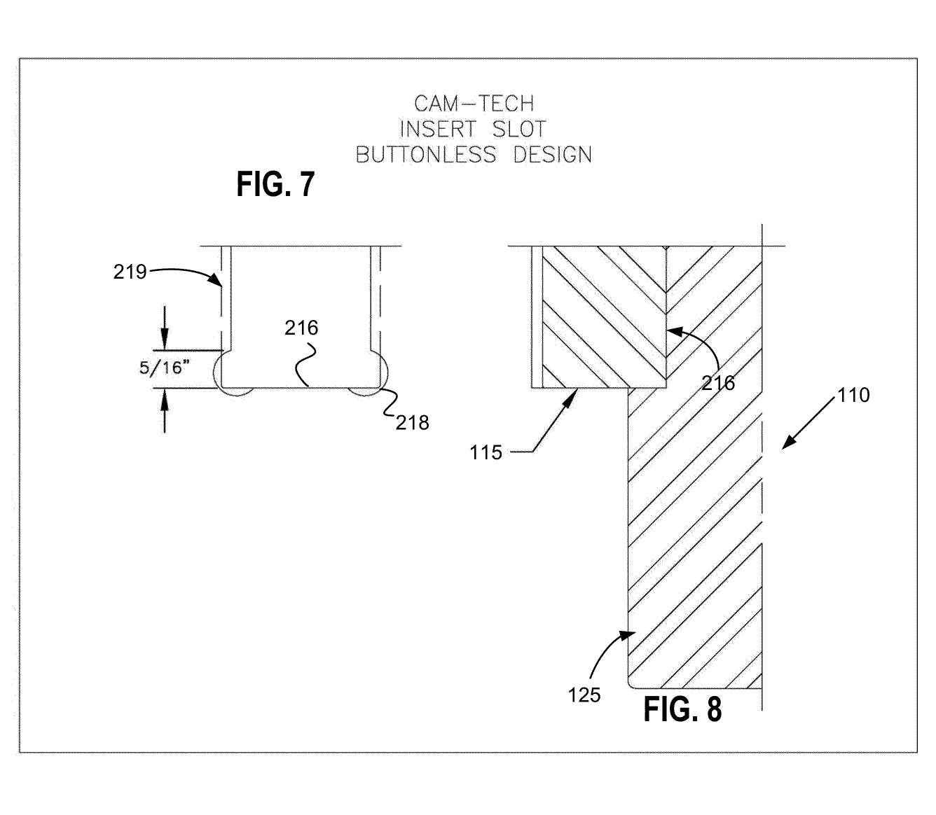

FIG. 7 is a top view of a portion of a slip segment showing the toe of an insert slot design for inserts according to an example embodiment, and FIG. 8 is a side view of FIG. 7 on a slip segment. Referring to FIGS. 7 and 8, the insert slot 216 of the example embodiments employs milled corner holes 218. As such, these holes 218 are above the toe 125 area so as not to be in the flex zone where there could be a radial stress causing toe 125 breakage into the pipe hole. This was not possible with the half-moon design because the half moon design must be machined into the toe area due to its size. In the conventional design, the toe area is filled back in by the half moon but it is not solid. It is only a weld attachment in one spot.

The design described herein, on the other hand, is a solid design in this area, so any flex or movement will not cause failure of the toe 125. The new design is much stronger due to the fact that it remains above and hence out of the toe 125 area.

Also, no weldments are required. There is no extra half-moon welded piece, so the issue of potential gaps or mismatch between a welded closeout and cast material (i.e., half-moon and slip segment) has been eliminated. Thus, all the material for the insert slot 216 is made of casting; this means that the tensile properties and yield of the material can be definitively known and tested, i.e., what it takes to break it. Designers can therefore have a constant and can rate the slip 100, e.g., how much weight the slip 100 will hold before it breaks.

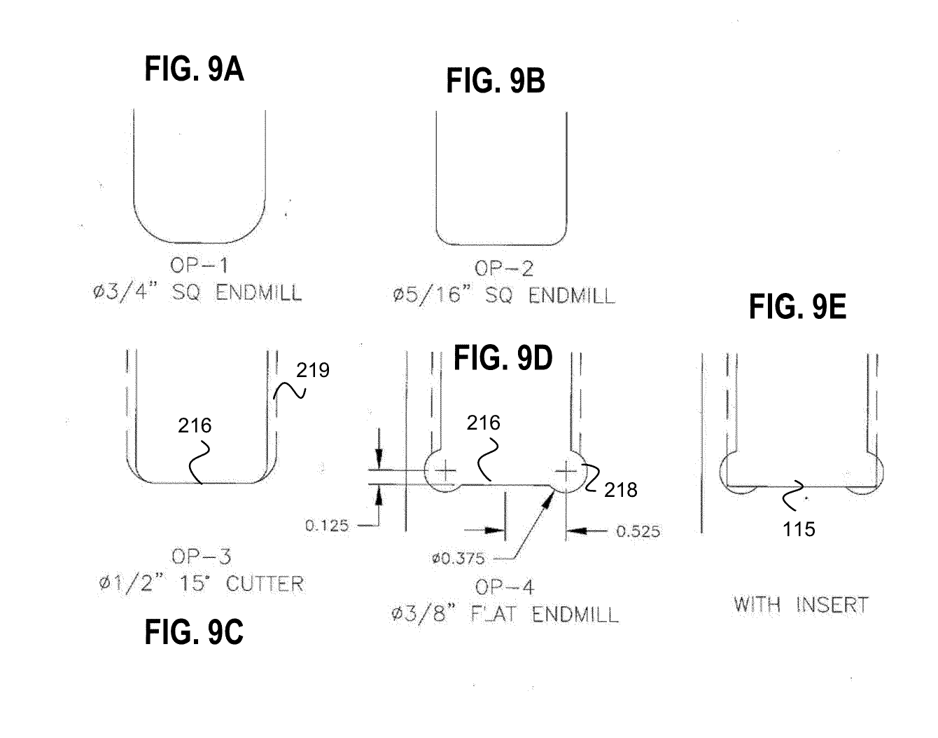

FIGS. 9A to 9E illustrates a process for fabricating an insert slot in a slip segment according to an example embodiment. Initially in FIG. 9A, a piece of cast steel billet that will form the insert slot 216 of the slip segment 110 is milled using precision computer numerically controlled (CNC) machining centers, such as in a straight end mill with a straight mill ¾″ cut. Next, at FIG. 9B, a 5/16″ square end mill cut is applied to make the radiuses of the eventual corner holes 218 a bit smaller and square the corners so the insert 115 will sit flat on the bottom of the cutout (bottom of insert slot 116). In FIG. 9C, a dovetail cutter is employed to groove a 15° angled groove (½″ deep cut) down both vertical sides of the billet, top to bottom (see dotted lines). This is done down the length of the slip segment 110. To create the corners 218, a flat (trig) end mill creates a ⅜″ deep hole with a ⅛″ radius (FIG. 9D) so as to relieve the corners at the bottom of the slip segment 110 and thus form the bottom of the insert slot 216. FIG. 9E shows what an insert 115 would look like in the completed slot 216, flush against the bottom groove with the corners 218 providing ample space for the ends of the insert 115.

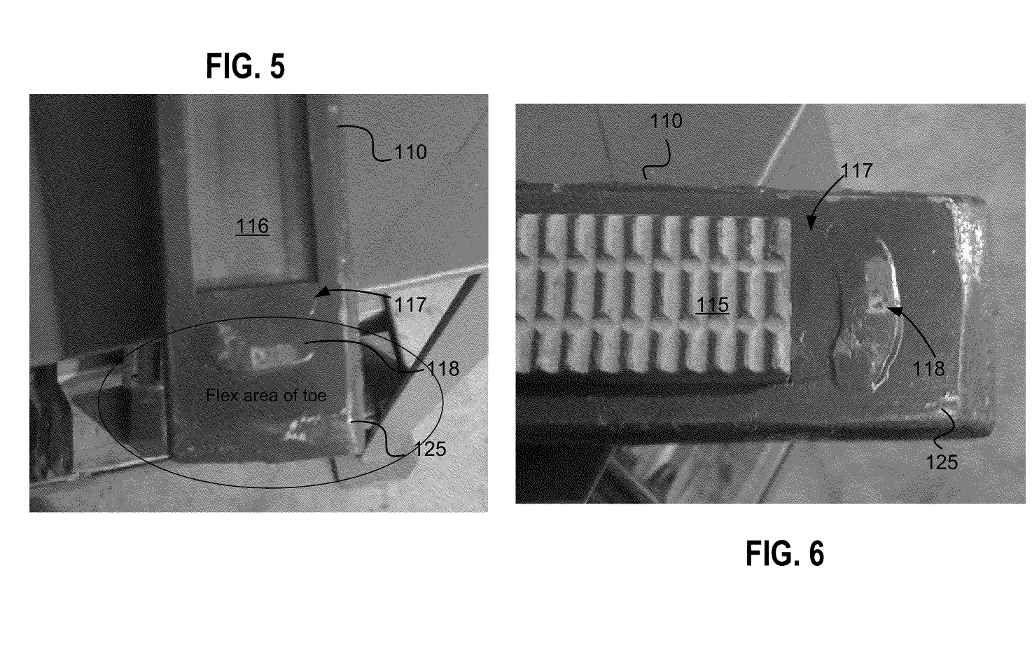

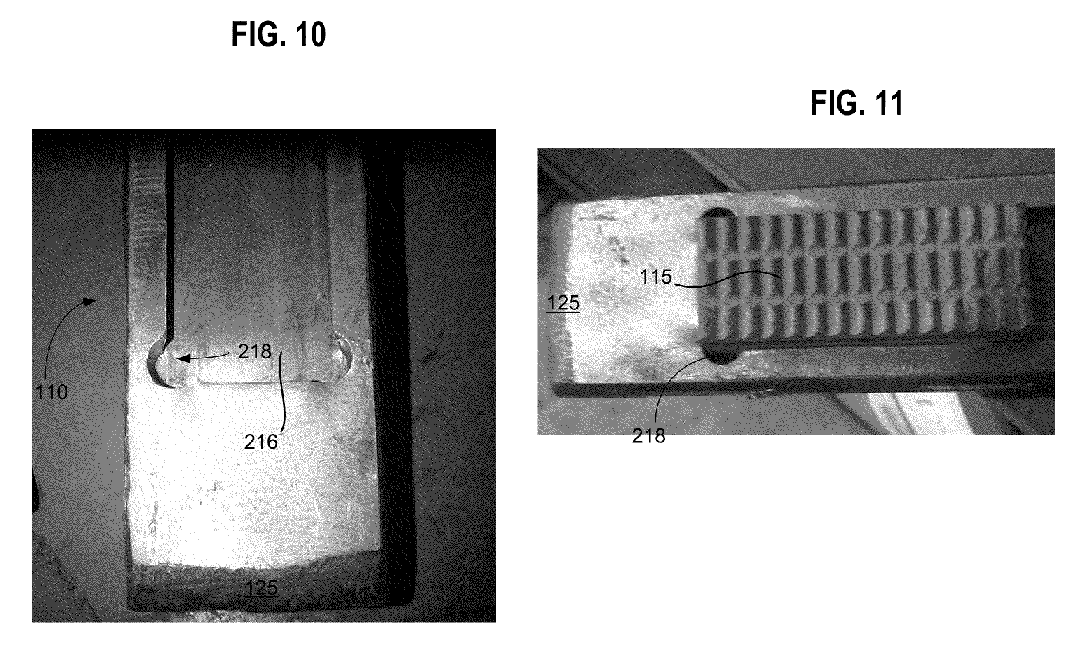

FIG. 10 is a photograph of a top view of a portion of a slip segment showing the insert slot design of the example embodiment at the segment toe without inserts therein, and FIG. 11 is a photograph of a top view of a portion of a slip segment showing the insert slot design of the example embodiment with inserts installed in the slot channel. In FIG. 10, the insert slot 216 design has no separate parts welded in, and machining stops above the toe 125 area. Additionally, it does not matter how the insert 115 (not shown) rests on the bottom of the slot 216. FIG. 11 shows the example slot 216 design with the insert 115 installed. The machining stops ¾″ above where the conventional design does, and does not extend into the toe 125 area like the conventional half-moon design of FIGS. 5 and 6. As can be seen, there is no welded-in part, the interface between the bottom of the insert 115 and the slot 216 does not matter, and this design is repeatable and can be controlled for testing.

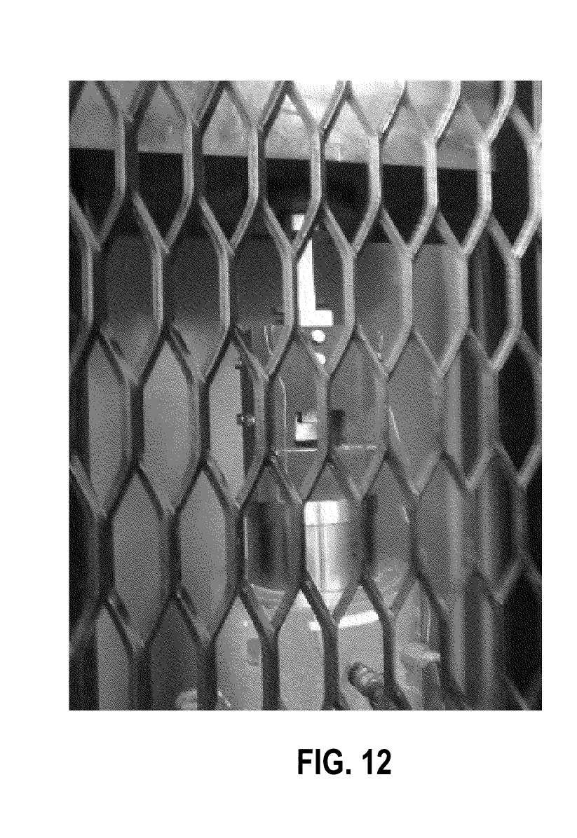

FIG. 12 is a photograph of a test apparatus used to test the strength of a segment toe with the insert slot design of the example embodiment. The apparatus of FIG. 12 is a hydraulic ram pushing an insert down into an insert slot. This apparatus was set to test and measure the force needed to break an insert slot of a slip segment (at the toe area of the slip segment) for any type of slip (power slip, hand slip, etc.). Both the conventional half-moon insert slot design and the example insert slot design described herein were tested.

A sampling was done every hundredth of a second. Two (2) strain gauges were used to measure force at two (2) separate locations: (a) strain at the toe 125 (flex in the toe); (b) strain at where the bottom of the insert 115 sits in the insert slot 116/216. The following TABLE summarizes the results from this comparative test.

TABLE

| | Generic | Generic | |
|---|---|---|---|
| | 350 Ohm | 350 Ohm | 400 Ton jack |
| | Uniaxial | Uniaxial | on Channel 1 |
| | Strain Gage | Strain Gage | calibrated |
| | on channel 1 | on channel 2 | values 121 (lb) |
| | [001] MAX Strain | [002] MAX Strain | Maximum |
| Half-Moon | 4906 | | 88887 |
| Design | | | |
| Half-Moon | | 8879 | 96446 |
| Design | | | |
| Example | 8192 | | 104004 |
| Embodiment | | | |
| Example | | 9638 | 104004 |
| Embodiment | | | |

Referring to the Table, for the channel 1 strain in the toe area, the example embodiment showed about a 17% improvement in strength before failure (failing at 104004 lb versus 88887 for the half-moon design). For the insert slot/insert strain point, the example embodiment showed about an 8% improvement. Over a series of test runs, the new design showed an approximate 20% strength improvement as compared to the conventional insert slot design.

The example insert slot and method of making thereof may be applicable to Pipe slips, drill collar slips, hand slips, etc. The slip formed with this insert slot technology provides a slip which is made repeatable and allows the manufacturer to provide a constant to rate slips, something heretofore which has not been contemplated in the industry.

The example embodiments being thus described, it will be obvious that the same may be varied in many ways. Such variations are not to be regarded as departure from the example embodiments, and all such modifications as would be obvious to one skilled in the art are intended to be included in the following claims.

I claim:

1. An insert slot for a slip segment of a rotary hand slip, comprising:
a milled recess cut into a metal slip segment so as to form a rectangular-shaped insert slot designed to receive an insert therein used in the hand slip, and
circular corners drilled into the slip segment at two lower corner locations of the insert slot so as to relieve two bottom end corners of the slot.

2. The insert slot of claim 1, wherein the slip segment has a toe area at a lower end thereof, the corners holes being located above the toe area of the slip segment so as not to be in a flex zone area where radial stress can break the toe off.

3. The insert slot of claim 1, wherein the insert slot is weld-free.

4. The insert slot of claim 1, wherein all material forming the insert slot is made of casting to permit tensile properties and yield of the material to be known and tested.

5. A method of fabricating an insert slot for a slip segment of a rotary hand slip, comprising:
straight end milling a billet of metal serving as the slip segment to a first depth to form a generally rectangular-shaped insert slot therein,
square end milling the billet to square the corners of the insert slot,
applying a dovetail cut to create a groove along lengthwise sides of the insert slot, and
flat end milling the billet at two lower corners of the formed insert slot to create circular corner holes therein.

6. The method of claim 5, wherein straight end milling further includes applying a ¾″ deep straight mill cut to the billet to form the insert slot therein.

7. The method of claim 5, wherein square end milling further includes applying a 5/16″ deep square mill cut to the billet to square the corners.

8. The method of claim 5, wherein applying the dovetail cut includes employing a dovetail cutter to groove a 15° angled groove at a depth of ½″ down both vertical sides of the billet, top to bottom.

9. The method of claim 5, wherein flat end milling includes employing a flat end mill to create a ⅜″ hole at a radius of ⅛″ so as to form the circular corner holes.
